(19) United States
(12) Patent Application Publication
(10) Pub. No.: US 2026/0220446 A1
(43) Pub. Date: Jul. 30, 2026

(54) LARGE LANGUAGE MODEL ON-CHIP INFERENCES

(71) Applicant: INTERNATIONAL BUSINESS MACHINES CORPORATION, Armonk, NY (US)

(72) Inventors: Rathinakumar APPUSWAMY, San Jose, CA (US); Michael Vincent DEBOLE, Poughkeepsie, NY (US); Brian Seisho TABA, Cupertino, CA (US); Steve Kyle ESSER, San Jose, CA (US); Jeffrey L. MCKINSTRY, San Jose, CA (US); Deepika BABLANI, San Jose, CA (US); Dharmendra S. MODHA, San Jose, CA (US)

(21) Appl. No.: 19/041,682

(22) Filed: Jan. 30, 2025

(51) Int. Cl. G06N 3/063; G06N 3/0455; G06N 3/0499

(52) U.S. Cl. CPC G06N 3/063; G06N 3/0455; G06N 3/0499

(57) ABSTRACT

Computer implemented methods, systems, and computer program products include program code executing on a processor(s) which obtain a large language model (LLM) for execution. The program code partitions the LLM, where each partition comprises a transformer layer of one or more transformer layers, and wherein the one or more transformer layers are situation between an embedding layer of the LLM and an output layer of the LLM, where layers of the LLM comprise the one or more transformer layers, the embedding layer, and the output layer. The program code performs the inferences with activation-forwarding at each of the one or more transformer layers, the inferences with activation-forwarding.

### STATEMENT REGARDING FEDERALLY SPONSORED RESEARCH OR DEVELOPMENT

This invention was made with government support under FA8750-19-C-1518 awarded by the USAF/AFMC Air Force Research Laboratory. The government has certain rights in the invention.

### BACKGROUND

One or more aspects relate, in general, to facilitating processing within a computing environment, and in particular, to minimizing communication overhead by using activation-forwarding.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Large language models (LLMs) are deep learning models that are pre-trained on vast amounts of data. Transformer LLMs refer to LLMs that are capable of unsupervised training and can learn to understand basic grammar, languages, and knowledge. The underlying transformer for a transformer LLM is a set of neural networks that consist of an encoder and a decoder with self-attention capabilities. The encoder and decoder extract meanings from a sequence of text and understand the relationships between words and phrases in it. Unlike earlier recurrent neural networks (RNN) that sequentially process inputs, transformers process entire sequences in parallel. In addition to utilizing CPUs to train LLMs, data scientists can also use GPUs for training transformer based LLMs, significantly reducing the training time.

Chatbots are interfaces utilized to interact with LLMs.

A neural network (NN) refers to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. For this reason, LLMs can utilize neural networks to determine priorities of tasks based on inputs, including natural language inputs.

LLM inference is the process by which LLMs generate responses to user prompts. The LLM receives input (e.g., from a user), converts the input into tokens, which are words or parts of words, which can be converted into numerical values. The LLM decodes the input meaning that it utilizes knowledge it gained during training to predict the most likely tokens in the sequence and decodes these tokens into text outputs. LLM inference is used for a variety of tasks, including generating text, summarizing documents, and/or retrieving information. Inference performance is a factor that indicates how well an LLM is performing. To measure inference performance, one measures the speed and response times of the model. Inference performance indicates how efficiency, reliability, and consistency of an LLM.

### SUMMARY

Shortcomings of the prior art are overcome, and additional advantages are provided through the provision of a computer-implemented method for performing inferences with activation forwarding. The method can include: obtaining, by one or more processors of a host, a large language model (LLM) for execution by the one or more processors; partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and performing, by the one or more processors, the inferences with activation-forwarding at each of the one or more transformer layers, the inferences with activation-forwarding comprising: storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

Shortcomings of the prior art are overcome, and additional advantages are provided through the provision of a computer program product for performing inferences with activation forwarding. The computer program product comprises a storage medium readable by one or more processors and storing instructions for execution by the one or more processors for performing a method. The method includes, for instance: obtaining, by the one or more processors of a host, a large language model (LLM) for execution by the one or more processors; partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and performing, by the one or more processors, the inferences with activation-forwarding at each of the one or more transformer layers, the inferences with activation-forwarding comprising: storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

Shortcomings of the prior art are overcome, and additional advantages are provided through the provision of a system for performing inferences with activation forwarding. The system includes: a memory, one or more processors in communication with the memory, and program instructions executable by the one or more processors via the memory to perform a method. The method can include: obtaining, by the one or more processors of a host, a large language model (LLM) for execution by the one or more processors; partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and performing, by the one or more processors, the inferences with activation-forwarding at each of the one or more transformer layers, the inferences with activation-forwarding comprising: storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a block diagram that illustrates various aspects of an activation forwarding model of the present disclosure;

FIG. 3 illustrates various aspects of an LLM as utilized in certain of the examples in the present disclosure;

FIG. 4 illustrates aspects of a given transformer layer of an LLM in accordance with various aspects of the present disclosure;

FIG. 5 illustrates an LLM as processed utilizing aspects of the present disclosure and include granular aspects at each transformer layer to show the integration of the activation fast-forwarding in the technical architecture;

FIG. 6 illustrates aspects of a given transformer layer of an LLM in accordance with various aspects of the present disclosure;

FIG. 7 illustrates an LLM as processed utilizing aspects of the present disclosure and include granular aspects at each transformer layer to show the integration of the activation fast-forwarding in the technical architecture;

FIG. 8 partition an LLM and store the partitions on a directed-acyclic graph of inference chips with on-chip memory and perform inference with activation-forwarding utilizing this directed acyclic graph structure LLM in accordance with various aspects of the present disclosure;

FIG. 9 illustrates a transformer layer according to some aspects of the present disclosure where the transformer block is stored on one inference chip or inference accelerator and where the program code utilizes KV caching;

FIG. 10 illustrates a transformer layer according to some aspects of the present disclosure that includes KV caching in addition to utilizing the feed forward model described herein to support multiple user sessions;

FIG. 11 illustrates a transformer layer according to some aspects of the present disclosure that includes KV caching in addition to utilizing the feed forward model described herein to support multiple user sessions;

FIG. 12 illustrates a transformer layer according to some aspects of the present disclosure where program code stores multiple sets of instructions in a sequence of chips with on-chip memory and selects a set to be executed during runtime; and

FIG. 13 illustrates a transformer layer according to some aspects of the present disclosure where program code modifies and uses the same set of instructions stored in the sequence of chips with on-chip memory for updating the KV cache and generating several tokens based on the token ID.

### DETAILED DESCRIPTION

The computer-implemented methods, computer program products, and systems described herein comprise program code executing on one or more processors that substantially minimizes communication overhead within the computing system by utilizing activation-forwarding. In some of the examples herein, program code executing on one or more processors partitions an LLM and stores these partitions on a sequence of chips with on-chip memory. The program code then performs inferences with activation-forwarding. In some examples, the program code partitions the LLM into smaller networks so that all the trained weights contained in each of the smaller partitions can be stored in the available on-chip memory of a single chip. In order to enhance performance of LLMs, certain of the examples herein integrate what is referred to an both an inference accelerator or an inference chip. In general, an accelerator refers to a solution, which can be a custom hardware solution, that accelerates transformer-based LLMs, enabling faster and more efficient inference.

An LLM is a type of artificial NN that accepts one or more inputs and produces one or more outputs. The program code of the LLM weights the inputs and/or outputs and these weighting mechanisms, which can include machine learning algorithms, can be trained to process, for example, human language in electronic form. A component of the functionality of an LLM can be referred to as a neural network weight. Neural network weights indicate how much an input matters to a neuron (of the NN), and how much the input can activate the neuron or help with a prediction. An LLM is trained to learn weights. When an LLM is trained the NN can change the weights based on the training data. The LLM can store the weight as tensors, which are multi-dimensional arrays that can store numerical values. Additionally, the weights in an NN can vary based on network type. For example, in an LLM, a weight can emphasize a word or language token (e.g., output). Weights in NNs (including LLMs) can be understood as being similar to synapses in biological neural networks.

Various terminology related to LLMs is used herein to describe the examples disclosed herein. The term “inference” can be used to refer to an NN performing a sequence of computations on one or more inputs and producing one or more output. A “token” refers to one or more outputs generated by a partition of an LLM and in NNs both the inputs as well as the inputs can be referred to as tokens. LLMs are trained to accomplish tasks and depending on the particular task which a given LLM is trained to accomplish, the number of possible tokens generated by the LLM, at each or any steps, which is referred to as the “vocabulary” of the LLM, can number in the tens of thousands. In some examples, a human language or a computer language is represented in electronic form as a sequence of tokens, and the NN generates a human language or a computer language that is also represented in electronic form as a sequence of tokens. LLMs can be trained to accomplish various tasks, including but not limited to processing (e.g., weighing) one or more human languages (input in electronic form), to generate outputs that include categorizations of the input language(s) and/or relevant parts of the input language(s). Another possible tasks which an LLM can be trained to accomplish, is to process human languages input in electronic form to generate additional language in electronic form as its output. Depending on the LLM and its training, the output can include an answer to a question contained in the input and/or a continuation of a conversation contained in the input. One function of an LLM is as a translator as an input can be a term in one language and its output can be that term in another language. In addition to human language inputs, some LLMs can be trained to process one or more computer programming languages. These LLMs can take a computer programming language as input and generate that provide a categorization of the input and/or relevant parts of the input as an output, including outputting as a different computer language, which could be an answer to a question or a continuation of the input. A NN can include a transformer which is building block of the NN in that includes an attention sub-block, followed by a feed-forward sub-block.

In some examples of the computer-implemented methods, computer program products, and systems described herein, a number of chips can be arranged (by the program code) in a sequence of processing stages such that each stage contains one or more inference chips. The program code can store each partition of the network in one or more inference chips. The examples herein utilize a computational model to enable communications between any two inference chips or between an inference chip and a host machine. The computational model imposed by the program code limits these communications to outputs generated by an inference chip in response to one or more inputs received. This model is referred to herein as activation forwarding. This communication (the activation forwarding) can utilize direct access memory (DMA) of the computing system, or it can be accomplished indirectly via a host processor. The activation forwarding model of computation utilized by the examples herein significantly reduces the quantity of bits communicated between an inference chip and external memories as well as between inference chips. This reduction occurs because the program code in the examples herein translates communications into a simpler system design and increases inference speed, which reduces energy consumption.

As will be described in greater detail herein, energy consumption is reduced in computing systems into which the examples herein are implemented through storing partitioned model in on-chip memory and using activation forwarding in part because of the flexibility of LLMs. LLMs can contain billions of weights that program code executed by one or more processors (that can comprise machine learning algorithms of the LLM) learn from training data. When making the inference noted above, in the examples, herein, the program code reads these billions of weights from wherever they are stored so that arithmetic and multiplication units can perform computations to generate the outputs. By utilizing an inference chip in the examples herein that stores these weights in its on-chip memory, the program code generating the output does not need to wait for the weights to be read from an external memory. Rather, the program code comprising the inference chip can (e.g., quickly) read required weights from its on-chip memory, providing a significant advantage in avoiding system latency (e.g., the time between when the inference chip receives one or more inputs and the time when the inference chip can generate its outputs). In addition, the reduced time to perform one inference step also translates into an increased number of inference steps performed per unit time.

The computer-implemented methods, computer program products, and computer systems comprise program code executing on one or more processors that partitions transformer-based LLMs and stores partitions on a sequence of chips with on-chip memory and performs inferences with activation forwarding. In some examples, program code executing on one or more processors initializes a key-value (KV) cache stores the content on a sequence of chips with on-chip memory and generates user-response tokens and updates the KV cache using activation-forwarding. In some examples, the program code can sustain multiple user-sessions are sustained on a sequence of chips with on-chip memory by storing KV cache for each session in chip memory and performing inference with activation forwarding. In some examples, multiple sets of instructions are stored in the sequence of chips with on-chip memory and the program code selects a different set to be executed during runtime based on (i) user session identifier (ID), and (ii) KV cache initialization versus new token generation. In some examples, the program code modifies the set of instructions stored in the sequence of chips with on-chip memory to update the KV cache and generate several tokens based on the token ID.

The examples herein are inextricably linked to computing and are directed toward a practical application. An example of a practical application to which the examples herein are directed to is reducing energy consumption use in computing systems. To reduce energy consumption, the examples herein include an activation forwarding model of computation. Utilization of this model significantly reduces the quantity of bits communicated between an inference chip and external memories as well as between inference chips themselves. This reduced communicating requirement translates into a simpler system design, increased inference speed, and reduced energy consumption. Thus, the examples herein represent improvements to processing within a computing system, rendering the examples herein inextricably tied to computing.

The examples herein provide significantly more than existing approaches to utilizing LLMs in processing. As discussed above, LLMs executed in the absence of activation forwarding are inefficient insofar as energy consumption, processing costs, and computing resources. The examples herein substantially minimize communication overhead within the computing system.

The examples herein include computer-implemented methods, computer program products, and computer systems for performing inferences with activation forwarding. The examples can include a computer-implemented method that includes program code executing on one or more processors of a host that obtaining a large language model (LLM) for execution by the one or more processors. The program code partitions the LLM, where each partition comprises a transformer layer of one or more transformer layers, and where the one or more transformer layers are situation between an embedding layer of the LLM and an output layer of the LLM, wherein layers of the LLM comprise the one or more transformer layers, the embedding layer, and the output layer. The program code performs the inferences with activation-forwarding at each of the one or more transformer layers, the inferences with activation-forwarding. Performing the inferences includes storing the partitions on a sequence of chips utilizing on-chip memory, where the storing comprises storing one or more trained weights comprising each transformer layer, where each transformer layer, upon obtaining input from a preceding layer of the layers, generates an output at each layer, and where the output at each layer of the layers excluding output generated at the output layer comprises the input to a succeeding layer, and where the output generated at the output layer comprises a result of the LLM. This example represents an improvement to a computing system because energy consumption is reduced in the computing systems by storing a partitioned model in on-chip memory and using activation forwarding which is enabled by the flexibility of LLMs.

In some examples of the computer-implemented method each transformer layer performs a self-attention action and a feed forward action. These layers and the self-attention conserves power because the utilization of these structures reduces the quantity of bits communicated between an inference chip and external memories as well as between inference chips themselves.

In some examples of the computer-implemented method, each transformer layer utilizes the on-chip memory of a single chip. Power is conserved within the computing system by partitioning an LLM into smaller networks so that all the trained weights contained in each of the smaller partitions can be stored in the available on-chip memory of a single chip.

In some examples of the computer-implemented method, each transformer layer utilizes the on-chip memory of a two chips, wherein a first chip of the two chips in utilized for the self-attention action and the second chip of the two chips is utilized for the feed forward action. Separating the functionality of the LLM in this manner serves to conserve power but also to sustain multiple user-sessions on a sequence of chips with on-chip memory and perform inference with activation-forwarding.

In some examples of the computer-implemented method, the program code initializes a key-value (KV) cache from user input. The program code stores the KV cache on the sequence of chips utilizing the on-chip memory. The program code utilizes the activation-forwarding to generate user tokens and update the KV cache. The example provides a benefit because it enables program code to sustain multiple user-sessions by storing KV cache for each session in chip memory and performing inference with activation-forwarding.

In some examples of the computer-implemented method, the sequence of chips comprises directed-acyclic graph. This graph provides a benefit by processing inputs and producing outputs that can be communicated to one or more of the inference chips in a subsequent processing stage as inputs, which creates a flexibility in communication which conserves processing.

In some examples of the computer-implemented method, the program code storing the partitions comprises: the program code storing, for each transformer layer, multiple sets of instructions. This aspect provides flexibility because the program code can select a different set to be executed during runtime based on various factors.

In some examples of the computer-implemented method, at runtime, at a given layer of the one or more transformer layers, the program code selects, for execution, a given set of instructions from the multiple sets of instructions. The program code executes the given set of instructions. Enabling the selection of different sets of instructions and the execution of these instructions enables flexibility in the environment which improves processing and efficient resource utilization.

In some examples of the computer-implemented method, the program code selecting the given set of instructions comprises: the program code selecting the given set of instructions based on a characteristic from the group consisting of: user session identifier, and type of instruction. Enabling the selection of different sets of instructions and the execution of these instructions enables flexibility in the environment which improves processing and efficient resource utilization.

In some examples of the computer-implemented method, the type of instruction is either a KV cache initialization instruction or a new token generation instruction. Enabling the selection of different sets of instructions and the execution of these instructions enables flexibility in the environment which improves processing and efficient resource utilization.

In some examples of the computer-implemented method, the program code utilizing the activation-forwarding to generate user tokens comprises: the program code generating a number of tokens for a user, the generating comprising: at each inference step until a final inference step, the program code generating a token and utilizing the token as input at a next inference step. At the final inference step, the program code generates a special token indicating that the LLM has reached a completion state. Partitioning an LLM provides processing advantages including increasing processing efficiency by streamlining processing and this final stage provides the desired output more efficiently than in existing processing methods.

In some examples of the computer-implemented method, the program code augments the KV cache with each token of the number of tokens. The use of the KV enables a diversity of instructions to be utilized as well as generating a variety of outputs.

In some examples of the computer-implemented method, the program code generating and the augmenting are contemporaneous. This aspect takes advantage of the functionality of the LLM and its ability to fulfill various processing function contemporaneously and hence, streamline processing.

In some examples of the computer-implemented method, the LLM is transformer-based. Utilizing a transformer-based LLM introduces efficiencies into processing by limiting communications between aspects and minimizing power consumption.

In some examples of the computer program products disclosed herein, the computer program product comprises a storage medium readable by one or more processors and storing instructions for execution by the one or more processors for performing a method. The method can include program code partitioning an LLM, where each partition comprises a transformer layer of one or more transformer layers, and where the one or more transformer layers are situation between an embedding layer of the LLM and an output layer of the LLM, wherein layers of the LLM comprise the one or more transformer layers, the embedding layer, and the output layer. The program code performs the inferences with activation-forwarding at each of the one or more transformer layers, the inferences with activation-forwarding. Performing the inferences includes storing the partitions on a sequence of chips utilizing on-chip memory, where the storing comprises storing one or more trained weights comprising each transformer layer, where each transformer layer, upon obtaining input from a preceding layer of the layers, generates an output at each layer, and where the output at each layer of the layers excluding output generated at the output layer comprises the input to a succeeding layer, and where the output generated at the output layer comprises a result of the LLM. This example represents an improvement to a computing system because energy consumption is reduced in the computing systems by storing a partitioned model in on-chip memory and using activation forwarding which is enabled by the flexibility of LLMs.

In some examples of the computer program product, each transformer layer performs a self-attention action and a feed forward action. These layers and the self-attention conserves power because the utilization of these structures reduces the quantity of bits communicated between an inference chip and external memories as well as between inference chips themselves.

In some examples of the computer program product, each transformer layer utilizes the on-chip memory of a single chip. Power is conserved within the computing system by partitioning an LLM into smaller networks so that all the trained weights contained in each of the smaller partitions can be stored in the available on-chip memory of a single chip.

In some examples of the computer program product, each transformer layer utilizes the on-chip memory of a two chips, wherein a first chip of the two chips in utilized for the self-attention action and the second chip of the two chips is utilized for the feed forward action. Separating the functionality of the LLM in this manner serves to conserve power but also to sustain multiple user-sessions on a sequence of chips with on-chip memory and perform inference with activation-forwarding.

In some examples of the computer program product, the program code initializes a key-value (KV) cache from user input. The program code stores the KV cache on the sequence of chips utilizing the on-chip memory. The program code utilizes the activation-forwarding to generate user tokens and update the KV cache. The example provides a benefit because it enables program code to sustain multiple user-sessions by storing KV cache for each session in chip memory and performing inference with activation-forwarding.

In some examples of the computer program product, the sequence of chips comprises directed-acyclic graph. This graph provides a benefit by processing inputs and producing outputs that can be communicated to one or more of the inference chips in a subsequent processing stage as inputs, which creates a flexibility in communication which conserves processing.

In some examples of the computer program product, the program code storing the partitions comprises: the program code storing, for each transformer layer, multiple sets of instructions. This aspect provides flexibility because the program code can select a different set to be executed during runtime based on various factors.

In some examples of the computer program product, at runtime, at a given layer of the one or more transformer layers, the program code selects, for execution, a given set of instructions from the multiple sets of instructions. The program code executes the given set of instructions. Enabling the selection of different sets of instructions and the execution of these instructions enables flexibility in the environment which improves processing and efficient resource utilization.

In some examples of the computer program product, the program code selecting the given set of instructions comprises: the program code selecting the given set of instructions based on a characteristic from the group consisting of: user session identifier, and type of instruction. Enabling the selection of different sets of instructions and the execution of these instructions enables flexibility in the environment which improves processing and efficient resource utilization.

In some examples of the computer program product, the type of instruction is either a KV cache initialization instruction or a new token generation instruction. Enabling the selection of different sets of instructions and the execution of these instructions enables flexibility in the environment which improves processing and efficient resource utilization.

In some examples of the computer program product, the program code utilizing the activation-forwarding to generate user tokens comprises: the program code generating a number of tokens for a user, the generating comprising: at each inference step until a final inference step, the program code generating a token and utilizing the token as input at a next inference step. At the final inference step, the program code generates a special token indicating that the LLM has reached a completion state. Partitioning an LLM provides processing advantages including increasing processing efficiency by streamlining processing and this final stage provides the desired output more efficiently than in existing processing methods.

In some examples of the computer program product, the program code augments the KV cache with each token of the number of tokens. The use of the KV enables a diversity of instructions to be utilized as well as generating a variety of outputs.

In some examples of the computer program product, the program code generating and the augmenting are contemporaneous. This aspect takes advantage of the functionality of the LLM and its ability to fulfill various processing function contemporaneously and hence, streamline processing.

In some examples of the computer program product, the LLM is transformer-based. Utilizing a transformer-based LLM introduces efficiencies into processing by limiting communications between aspects and minimizing power consumption.

In some examples of the systems disclosed herein the system includes: a memory, one or more processors in communication with the memory, and program instructions executable by the one or more processors via the memory to perform a method. The method can include program code partitioning an LLM, where each partition comprises a transformer layer of one or more transformer layers, and where the one or more transformer layers are situation between an embedding layer of the LLM and an output layer of the LLM, wherein layers of the LLM comprise the one or more transformer layers, the embedding layer, and the output layer. The program code performs the inferences with activation-forwarding at each of the one or more transformer layers, the inferences with activation-forwarding. Performing the inferences includes storing the partitions on a sequence of chips utilizing on-chip memory, where the storing comprises storing one or more trained weights comprising each transformer layer, where each transformer layer, upon obtaining input from a preceding layer of the layers, generates an output at each layer, and where the output at each layer of the layers excluding output generated at the output layer comprises the input to a succeeding layer, and where the output generated at the output layer comprises a result of the LLM. This example represents an improvement to a computing system because energy consumption is reduced in the computing systems by storing a partitioned model in on-chip memory and using activation forwarding which is enabled by the flexibility of LLMs.

In some examples of the system, each transformer layer performs a self-attention action and a feed forward action. These layers and the self-attention conserves power because the utilization of these structures reduces the quantity of bits communicated between an inference chip and external memories as well as between inference chips themselves.

In some examples of the system, each transformer layer utilizes the on-chip memory of a single chip. Power is conserved within the computing system by partitioning an LLM into smaller networks so that all the trained weights contained in each of the smaller partitions can be stored in the available on-chip memory of a single chip.

In some examples of the system, each transformer layer utilizes the on-chip memory of a two chips, wherein a first chip of the two chips in utilized for the self-attention action and the second chip of the two chips is utilized for the feed forward action. Separating the functionality of the LLM in this manner serves to conserve power but also to sustain multiple user-sessions on a sequence of chips with on-chip memory and perform inference with activation-forwarding.

In some examples of the system, the program code initializes a key-value (KV) cache from user input. The program code stores the KV cache on the sequence of chips utilizing the on-chip memory. The program code utilizes the activation-forwarding to generate user tokens and update the KV cache. The example provides a benefit because it enables program code to sustain multiple user-sessions by storing KV cache for each session in chip memory and performing inference with activation-forwarding.

In some examples of the system, the sequence of chips comprises directed-acyclic graph. This graph provides a benefit by processing inputs and producing outputs that can be communicated to one or more of the inference chips in a subsequent processing stage as inputs, which creates a flexibility in communication which conserves processing.

In some examples of the system, the program code storing the partitions comprises: the program code storing, for each transformer layer, multiple sets of instructions. This aspect provides flexibility because the program code can select a different set to be executed during runtime based on various factors.

In some examples of the system, at runtime, at a given layer of the one or more transformer layers, the program code selects, for execution, a given set of instructions from the multiple sets of instructions. The program code executes the given set of instructions. Enabling the selection of different sets of instructions and the execution of these instructions enables flexibility in the environment which improves processing and efficient resource utilization.

In some examples of the system, the program code selecting the given set of instructions comprises: the program code selecting the given set of instructions based on a characteristic from the group consisting of: user session identifier, and type of instruction. Enabling the selection of different sets of instructions and the execution of these instructions enables flexibility in the environment which improves processing and efficient resource utilization.

In some examples of the system, the type of instruction is either a KV cache initialization instruction or a new token generation instruction. Enabling the selection of different sets of instructions and the execution of these instructions enables flexibility in the environment which improves processing and efficient resource utilization.

In some examples of the system, the program code utilizing the activation-forwarding to generate user tokens comprises: the program code generating a number of tokens for a user, the generating comprising: at each inference step until a final inference step, the program code generating a token and utilizing the token as input at a next inference step. At the final inference step, the program code generates a special token indicating that the LLM has reached a completion state. Partitioning an LLM provides processing advantages including increasing processing efficiency by streamlining processing and this final stage provides the desired output more efficiently than in existing processing methods.

In some examples of the system, the program code augments the KV cache with each token of the number of tokens. The use of the KV enables a diversity of instructions to be utilized as well as generating a variety of outputs.

In some examples of the system, the program code generating and the augmenting are contemporaneous. This aspect takes advantage of the functionality of the LLM and its ability to fulfill various processing function contemporaneously and hence, streamline processing.

In some examples of the system, the LLM is transformer-based. Utilizing a transformer-based LLM introduces efficiencies into processing by limiting communications between aspects and minimizing power consumption.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-NO only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

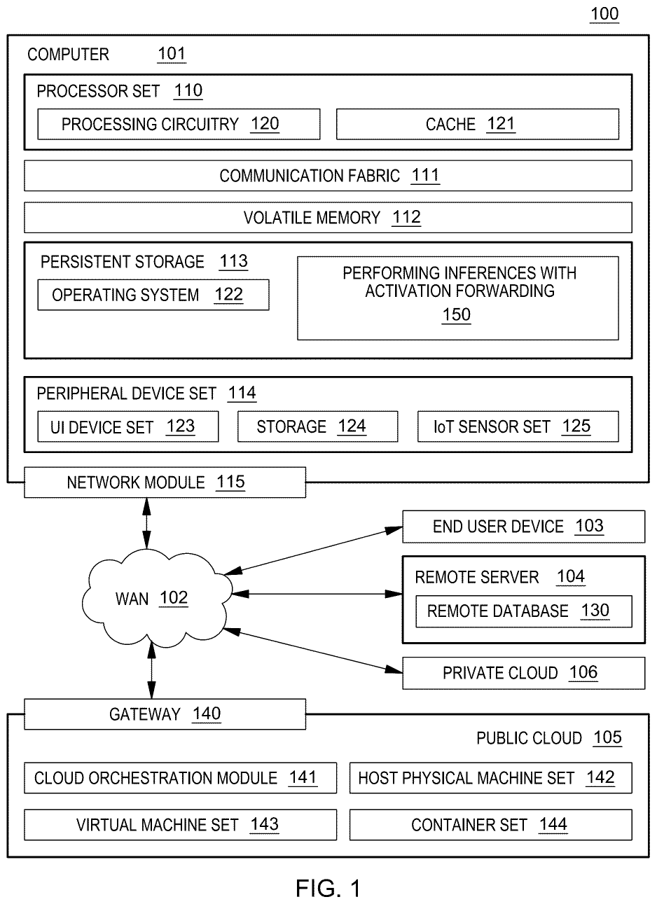

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code for performing inferences with activation forwarding 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

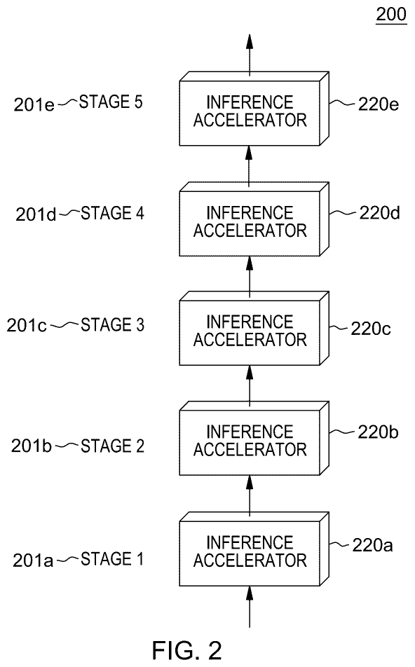

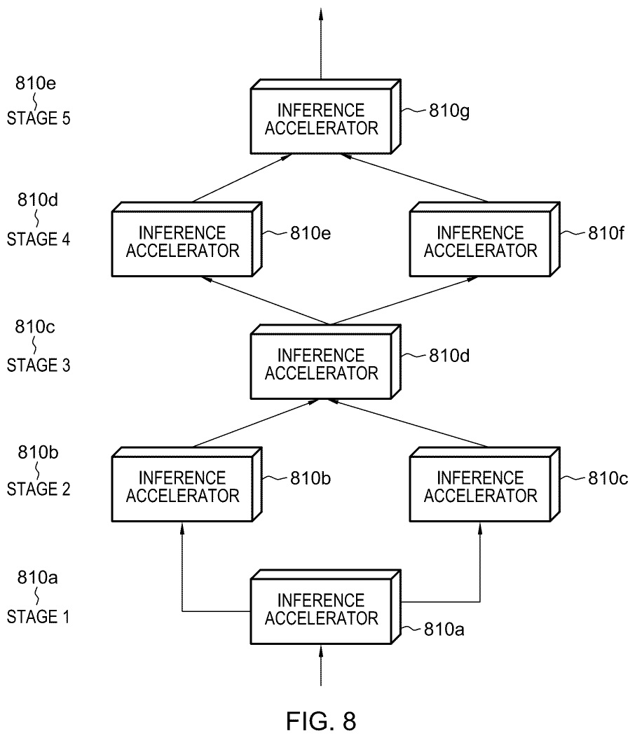

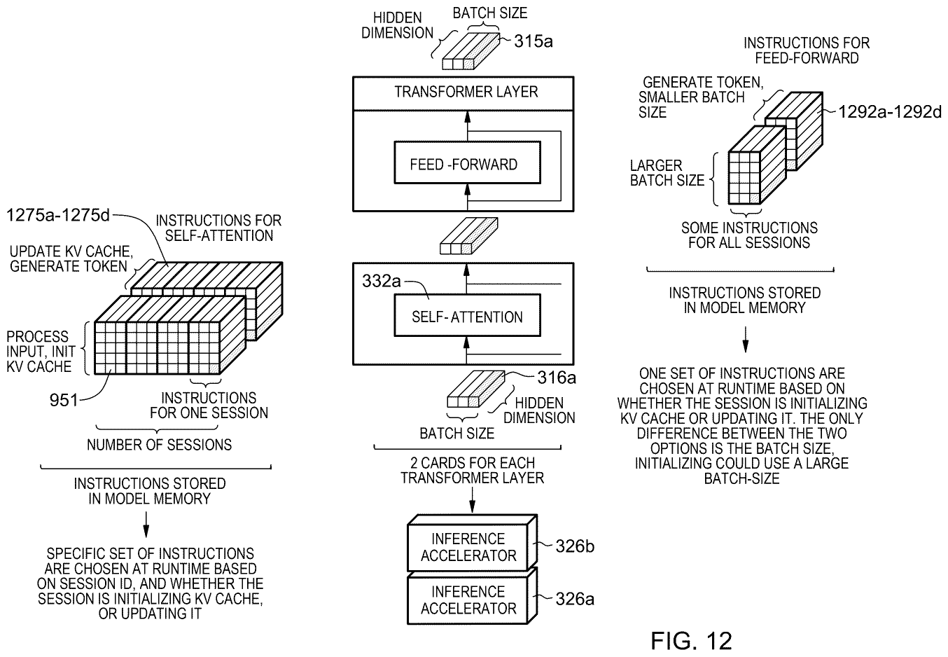

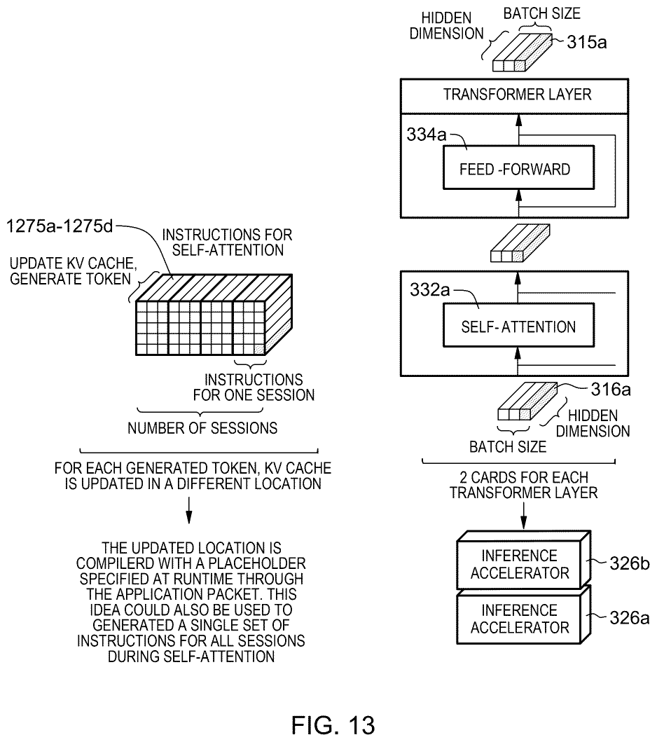

The examples herein include computer-implemented methods, computer program products, and computing systems for performing inference with activation-forwarding based on partitioning an LLM and storing the partitions on a sequence of chips with on-chip memories. FIGS. 2-13 illustrate various aspects of some examples of the operations of this fast-forward model. These illustrations are provided for illustrative purposes only and not to introduce any limitations. For example, FIGS. 2-7 provide illustrate various aspects of a method and a system to partition transformer-based LLMs which includes storing partitions on a sequence of chips with on-chip memory and performing inference with activation-forwarding. FIGS. 8-13 integrate a key-value (KV) caching into the depicted examples. Thus, in these examples, program code executing on one or more processors can initialize and store user input on a sequence of chips with on-chip memory and generate user-response tokens to update the KV cache using activation-forwarding. As illustrated in FIG. 12, the implementation of a KV cache in the examples herein enables program code in the examples herein to sustain multiple user-sessions are sustained on a sequence of chips with on-chip memory by storing KV cache for each session in chip memory and performing inference with activation-forwarding. FIG. 12 also illustrates the program code storing multiple sets of instructions in the sequence of chips with on-chip memory and selecting a different set is selected to be executed during runtime based on (i) user session ID, and (ii) KV cache initialization versus new token generation (depending on the type of instruction). FIG. 13 illustrates aspects of examples where program code modifies and uses the same set of instructions stored in the sequence of chips with on-chip memory for updating the KV cache and generating several tokens based on the token identifier (ID).

Referring first to FIG. 2, in some examples, program code executing on one or more processors partitions a single transformer block such that one chip stores and performs an inference with an attention block part of the transformer, and a subsequent chip in the sequence stores and performs an inference with a feed-forward block part of the transformer. To that end, FIG. 2 is a block diagram that illustrates various aspects of some examples herein. Specifically, FIG. 2 depicts the activation forwarding model 200 of computation utilized in the examples herein. In this activation forwarding model 200, program code executing on one or more processors, obtains a tensor (e.g., a weight of an LLM comprising a multi-dimensional array that can be stored as a numerical value) as input at an earlier stage, and outputs tensors to another inference accelerator (e.g., chip) in a subsequent stage. As depicted in FIG. 2, each inference accelerator 220a-220e (e.g., inference chip), obtains one or more inputs, processes those inputs, produces one or more outputs, and communicates the outputs are communicated to (e.g., at least one) inference accelerator 220a-220e (e.g., inference chip) in a subsequent processing stage 210a-210e, as inputs. Illustrated in FIG. 2 are five stages 210a-210e (which is provided as an example, only). An LLM, which can be understood as a transformer-based network that contains a number of weights (or “parameters”), is partitioned into smaller networks such that all the trained weights contained in each of the smaller partitions can be stored in the available on-chip memory of a single chip.

In FIG. 2, chips, referred to as either inference accelerators 220a-220e or accelerator chips, interchangeably herein, are arranged in a sequence of processing stages such that each stage contains one or more inference chips. Each of the partitions of the network can be stored in one or more of the inference accelerators 220a-220e or accelerator chips. Hence, the activation forwarding model 200 is a forwarding model in which the communication between any pair of the inference accelerators 220a-220e (e.g., inference chips) as well as any communication between the inference chips and a host computer (not pictured in FIG. 2) is limited to outputs generated by an inference chip (e.g., output tensors) in response to one or more inputs (e.g., input tensors) received. This activation communication, which can be referred to as activation forwarding, can either be direct using Direct Memory Access (DMA), and/or indirect with the help of a host processor. Although in FIG. 2 the inputs obtained by each subsequent stage 210b-210e are illustrated as originating from a preceding stage 210a-210d, at each stage, the inputs received can either be from an inference accelerator at a preceding stage or from a host computer.

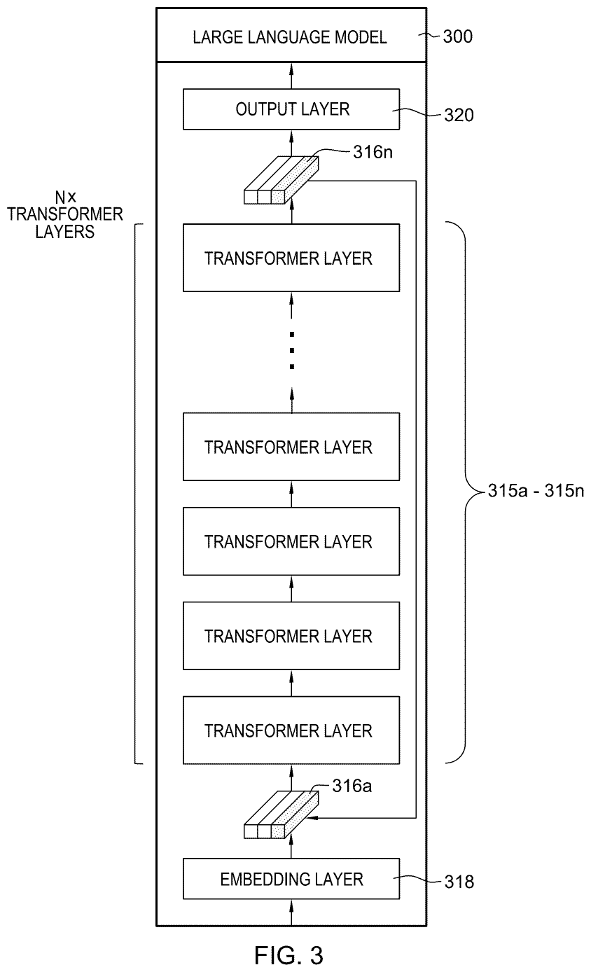

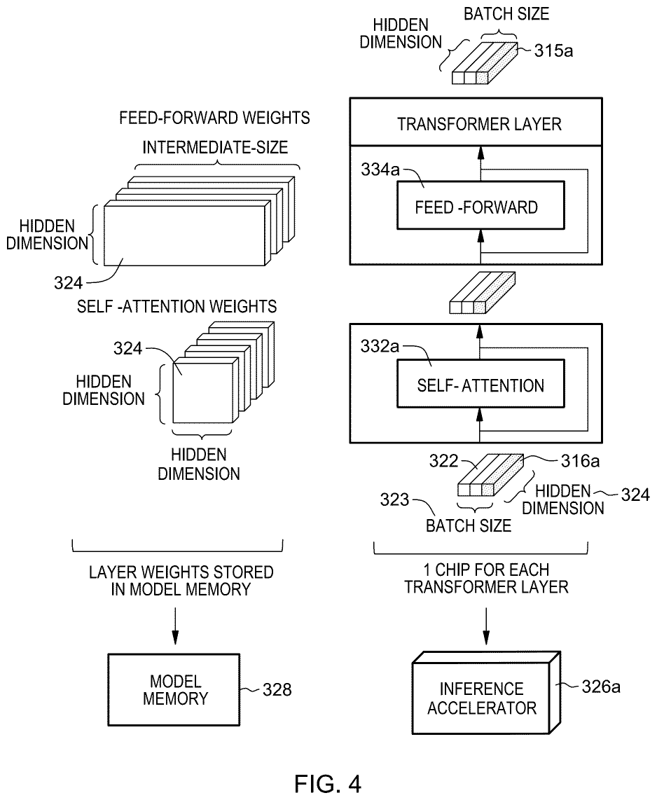

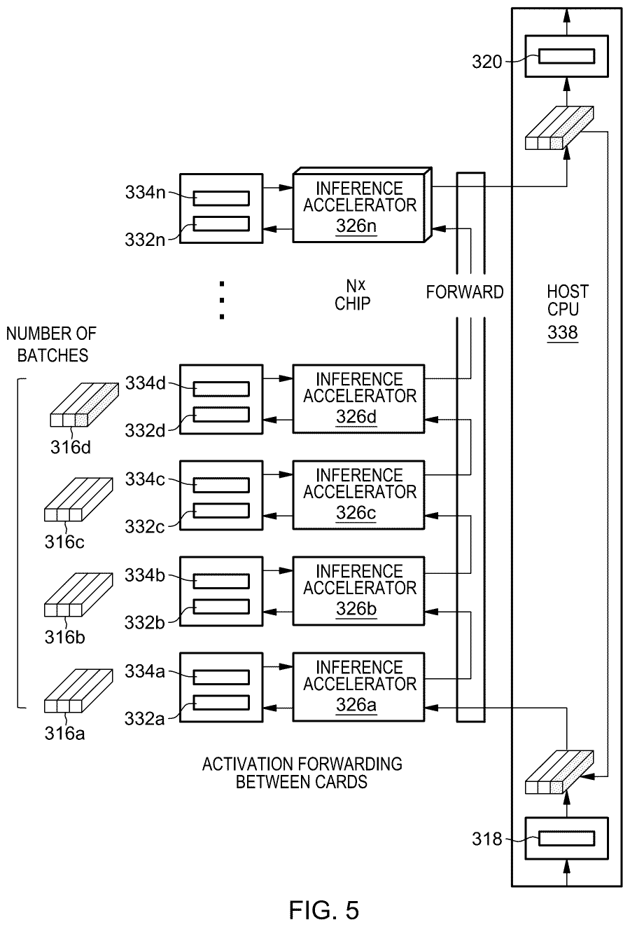

FIGS. 3-5 illustrate certain aspects of the examples herein where program code executing on one or more processors stores a transformer block on one inference chip. FIG. 3 illustrates various aspects of an LLM 300 as utilized in certain of the examples herein, with different levels of detail provided in each portion of the illustration. The LLM is comprised of various transformer layers 315a-315n. FIG. 4 illustrates aspects of a given transformer layer 315a of the LLM 300. FIG. 5 illustrates the whole of the LLM 300 (which is also illustrated in FIG. 3) but includes more granular aspects at each transformer layer 315a-315n to show the integration of the activation fast-forwarding in the technical architecture. As discussed above, this activation forwarding model of computation significantly reduces the number of bits communicated between an inference chip (e.g., inference accelerator 326a-326n) and external memories as well as between inference chips, simplifying system design and increasing inference speed, and reducing energy consumption. Transformer layers 315a-315n can be understood as hidden layer in the context of the NN because they are layers of neurons are neither input nor the output layers.

Referring first to FIG. 3, this is an overview of an LLM 300 provided without illustration of the examples herein and how the fast-forward model alters the processing within the LLM. This initial overview of an LLM 300 is also relevant to other examples herein of the activation forwarding model discussed herein. The LLM 300 is comprised of an NN built out of transformers or transformer layers 315a-315n. Each transformer layer 315a-315n, which can also be understood as a transformer block includes an attention sub-block, followed by a feed-forward sub-block. Self-attention, performed in the attention block, enables the LLM to attend to different positions of its input sequence to compute a representation of that sequence. It enables the LLM 300 to weigh the importance of each word in the sequence relative to others, capturing dependencies between different words in the input. A batch or number of batches 316a-n handled by the LLM comprises various transformer layers 315a-315n. The each batch 316a of the batches 316a-316n is informed by an embedding layer 318 which includes embeddings, which are components within LLMs comprised of elements that facilitate the adept processing and comprehension of natural language data by the program code comprising the LLM. The transformer layers 315a-315n of the batch 316a sequentially process the input and provide a result to an output layer 320. The output layer 320 is the final layer in the neural network (comprising the LLM 300) where the output is provided, e.g., from which the desired predictions are obtained. The output layer 320 is the layer of the NN that produces the desired final prediction. The program code comprising the output layer 320 can include its own weights and biases that the program code applies to derive a final output.

FIG. 4 illustrates a transformer layer 315a where the transformer block is stored on one inference chip or inference accelerator. In this example, a batch 322 of a given batch size 323 includes hidden dimensions 324 (e.g., representations of data within the hidden layers, which are the intermediary layers between the input and output layers). The transformer layer 315a of the LLM includes an inference accelerator 326a. The weights of the transformer layer 315a are stored by the program code in on-chip memory 328. The transformer layer 315a includes a self-attention stage 332a, which feeds a feed-forward stage 334a. This example includes only a single inference chip or accelerator.

As aforementioned, output tensors from one stage are forwarded to another chip in a subsequent stage, and this aspect is illustrated in FIG. 5. The calculations accomplished by the LLM 300 are separated into a number of batches 316a-316n. Each batch is processed on a chip that includes an inference accelerator 326a-326n. Each batch includes a self-attention stage 332a-332n, which feeds a feed-forward stage 334a-334n. Program code executing on one or more processors performs activation forwarding between cards (chips). As discussed above, each chip can obtain output tensors from a preceding chip and/or from a host CPU 338. LLMs contain billions of weights that are learned from training data. During an inference step, all of these billions of weights are read from wherever they are stored so that arithmetic and multiplication units can perform the computations needed to generate the outputs. In this example, the inference accelerator 326a stores the weights in its on-chip memory 328 so the program code of the LLM can avoid waiting for these weights to be read from an external memory. The program code of the inference accelerator 326a can read the weights from its on-chip memory 328 in a manner that avoids latency issues experienced in previous approaches. Latency in this context refers to the time between when the inference accelerator 326a or inference chip receives one or more inputs and the time when the inference accelerator 326a or inference chip can generate (e.g., all of) its outputs. Reducing the time to perform one inference step also translates into an increased number of inference steps performed per unit time.

Like FIGS. 3-4, FIG. 5 also illustrates a system where one transformer block is stored on one inference chip (e.g., inference accelerators 220a-220e) but illustrates the batches 330a-330n and activation forwarding between cards. FIG. 5 illustrates the embedding layer as well as the output layer but illustrates the partitioned approach of the evaluation by an LLM. In this overview, each batch 316a-316n utilizes an inference accelerator 326a-326n (each on a chip for a total of Nx chips). The LLM is processed on the host CPU 338. Each batch, as also illustrated in FIG. 4, includes a self-attention layer and a feed-forward layer. FIG. 5 illustrates how each partition of an LLM is partitioned into a smaller network such that all the trained weights contained in each of the smaller partitions are stored in the available on-chip memory of a single chip. FIG. 5 shows that a number of chips (Nx chips) are arranged in a sequence of processing stages such that each stage contains one or more inference chips. Each partition of the in this example is stored on one inference chip (in other examples, the partitions are stored on more than one chip). The communications to produce the output layer are between inference chips (e.g., inference accelerators 220a-220e) and inference chips and the host CPU 338 and is limited to outputs generated by each inference chip in response to one or more inputs received (e.g., activation-forwarding). As illustrated in FIG. 5, each inference chip, upon receiving one or more inputs, processes those inputs and produces one or more outputs, and those outputs are communicated to one or more of the inference chips in a subsequent processing stage as inputs. In the example in FIG. 5, every input to an inference chip is either from a host computer or communicated from another inference chip in a proceeding processing stage.

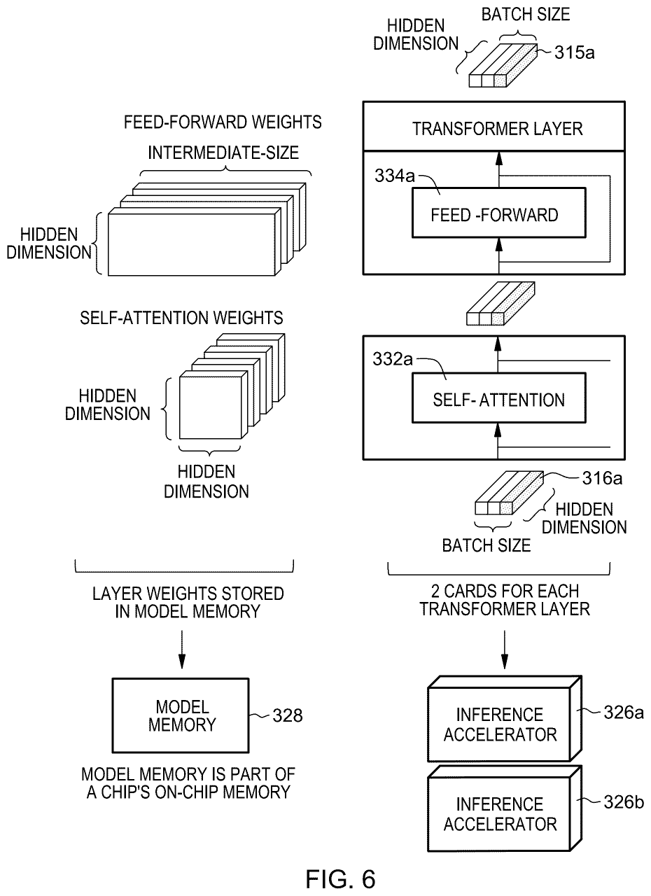

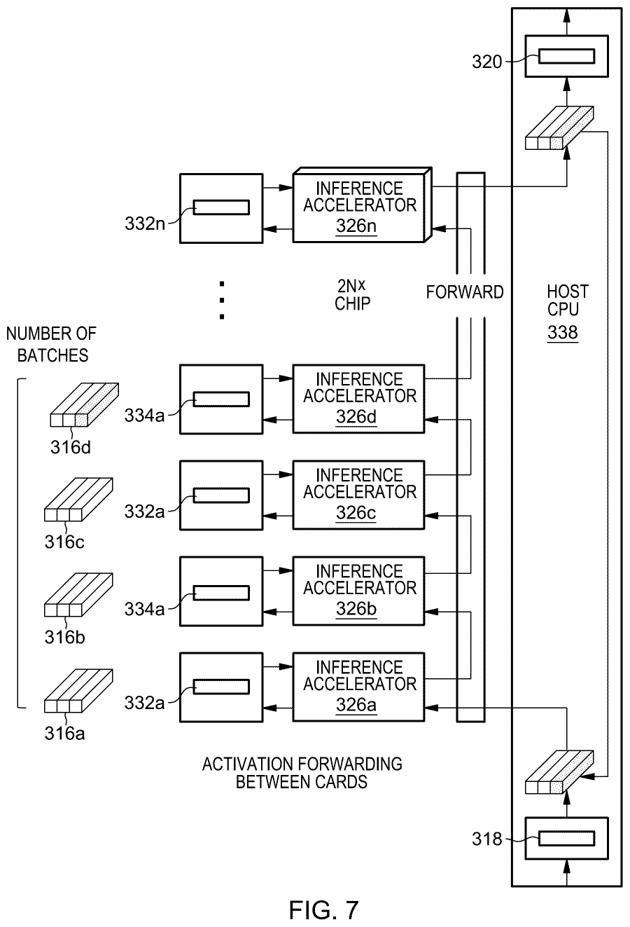

While FIGS. 3-5 illustrates various aspects of some examples herein where one transformer block is stored on one inference chip or inference accelerator, FIG. 3 and FIGS. 6-7 illustrate an example where each transformer block is stored in two inference chips or inference accelerators. FIG. 3 is repeated because from the vantage point of FIG. 2, a one chip or a two chip configuration are identical. The difference in the configuration is illustrated in FIGS. 6-7. FIG. 6 illustrates a batch and hence, a transformer layer 315a where the transformer block is stored on one inference chip or inference accelerator. FIG. 7 illustrates how each partition of an LLM is partitioned into a smaller network such that all the trained weights contained in each of the smaller partitions are stored in the available on-chip memory of a two chips.

FIG. 6 illustrates a transformer layer 315a where the transformer block is stored in two inference chips or inference accelerators. In this example, a batch 316a of a given batch size includes hidden dimensions 324 (e.g., representations of data within the hidden layers, which are the intermediary layers between the input and output layers). The transformer layer 315a of the LLM includes two inference accelerators 326a-326b. The weights of the transformer layer 315a are stored by the program code in on-chip memory 328. The transformer layer 315a includes a self-attention stage 332a, which feeds a feed-forward stage 334a. The self-attention stage 332a and the feed-forward stage 334a are each on their own inference accelerators 326a-326b.

Just as in the example with a single chip, in this two chip example, output tensors from one stage are forwarded to another chip in a subsequent stage. The calculations accomplished by the LLM 300 are separated into a number of batches 330a-330n. Each batch is processed on a chip that includes two inference accelerators 326a-326n. In a batch 316a-316n, one chip includes a self-attention stage 332a-332n, which feeds a second chip which is a feed-forward stage 334a-334n. Program code executing on one or more processors performs activation forwarding between cards (chips). As discussed above, each batch (which includes two chips in these examples) can obtain output tensors from a preceding batch and/or from a host CPU 338. LLMs contain billions of weights that are learned from training data. During an inference step, all of these billions of weights are read from wherever they are stored so that arithmetic and multiplication units can perform the computations needed to generate the outputs. In this example, the inference accelerators 326a-326b each store the weights in its on-chip memory 328 so the program code of the LLM can avoid waiting for these weights to be read from an external memory. The program code of the inference accelerators 326a-326b can read the weights from its on-chip memory 328 in a manner that avoids latency issues experienced in previous approaches.

Like FIG. 6, FIG. 7 also illustrates a system where one transformer block is stored in two inference chips but illustrates the batches 316a-316n and activation forwarding between cards. FIG. 7 illustrates the embedding layer as well as the output layer but illustrates the partitioned approach of the evaluation by an LLM. In this overview, each batch 316a-316n utilizes two inference accelerators (Nx chips). The LLM is processed on the host CPU 338. Each chip is either a self-attention layer or a feed-forward layer. FIG. 7 illustrates how each partition of an LLM is partitioned into a smaller network such that all the trained weights contained in each of the smaller partitions are stored in the available on-chip memory of two chips. FIG. 7 is similar to FIG. 5 but for the separation of sub-layers of each transformer layer over two chips.

The examples illustrated in FIGS. 3-7 store partitions of an LLM sequentially, as illustrated in FIG. 2. However, in some examples, the program code can partition an LLM and stores the partitions on a directed-acyclic graph of inference chips with on-chip memory and perform inference with activation-forwarding utilizing this directed acyclic graph structure in place of the sequential model illustrated in FIG. 2. FIG. 8 illustrates this directed acyclic graph structure. This directed acyclic graph structure can be utilized in examples where a single attention-block or feed-forward network of a transformer is mapped to multiple processors.

Referring to FIG. 8, in this configuration, a number of chips are arranged as an acyclic graph of processing stages 810a-810e such that each stage contains one or more inference chips. Thus, each of the partitions is stored in one of the inference chips. The directed acyclic graph of inference accelerators 820a-820g or chips performs inferences by using activation forwarding from one stage to a subsequent stage by either be direct using Direct Memory Access (DMA), or indirectly with the help of a host processor. As illustrated in the stages 810a-810e, during activation forwarding outputs generated by all the processors in a stage can be gathered by one processor and combined before forwarding to one or more processors in a subsequent stage or each processor in a stage can directly forward its outputs to one or more processors in a subsequent stage. Just as with the configuration in FIG. 2, in the configuration of FIG. 8, each inference chip or inference accelerator 820a-820g in a stage 810a-810e of the directed acyclic graph of processors, upon receiving one or more inputs, processes those inputs and produces one or more outputs, and those outputs are communicated to one or more of the inference chips in a subsequent processing stage as inputs. The stages 810a-810e obtain an input tensor and produce an output tensor.

Various examples herein can utilize KV caching, which is a technique that is utilized in LLM processing to optimize performance. KV caching refers to retaining (e.g., caching) and reusing the key and the value vectors from the previous iterations of an LLM to inform subsequent iterations. In some of the examples herein, including in the example in FIG. 8, program code initializes a KV cache from user input and stores KV cache on a sequence of chips with on-chip memory and generates user-response tokens with activation-forwarding. KV caching is often utilized during inference by all processors implementing LLMs on transformer blocks. KV caching refers to processors storing part of a computed outputs in response to one more inputs to be used during the subsequent inference steps. In certain of the examples herein, each chip stores the KV cache for each of the transformer attention blocks stored in its on-chip memory. Thus, the KV cache can be initialized when a chip receives a first input from a user (e.g., this first input can be generated from a prompt from a user). In some examples, the program code updates the KV cache every time a new token is generated and stored in the corresponding chip's on-chip memory. Like storing weights in on-chip memory, storing and updating KV cache in on-chip memory reduces the time that a processor or other computing units waits for cached data to be transferred from storage, resulting in lower latency and increased inference speed.

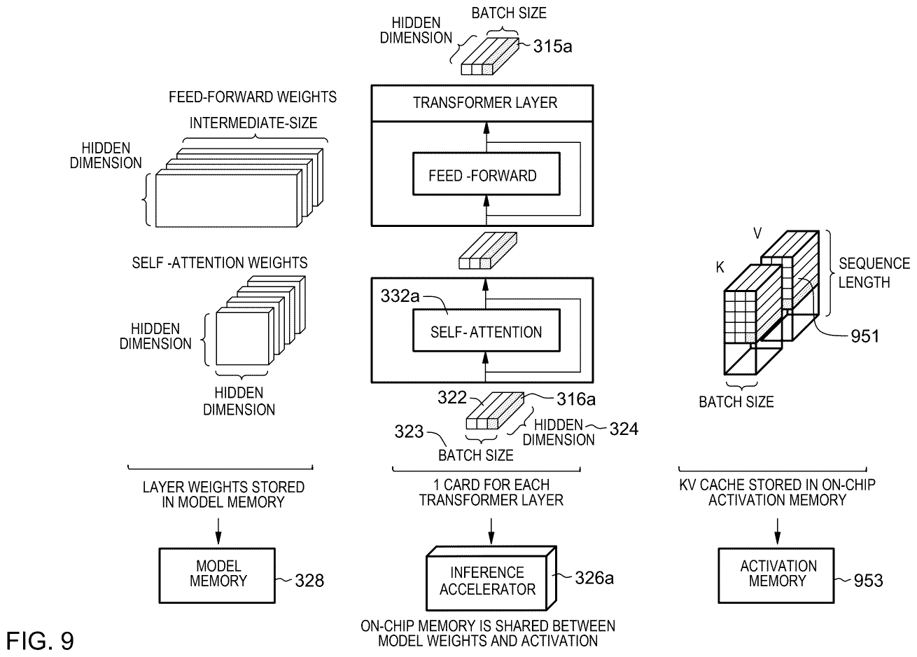

The inclusion of KV caching in various examples here and specifically storing and updating KV-cache in on-chip memory adds another elements to the existing examples discussed herein but does not disrupt the existing fast-forward model. Hence, certain of the figures and their descriptions are relevant whether KV caching is included or not. Examples herein which include KV caching can be understood as examples that support a single user session and those which support multiple user sessions. Additionally, in some examples, as with earlier examples, a single card is utilized for a given transformer layer while in other examples, two cards are utilized for a given transformer layer. Whether KV caching is included or whether there are one or two cards per transformer layers, FIG. 3 is relevant to the examples illustrated in FIGS. 9-XX as it provides an overview of an LLM 300. FIGS. 5-7 are also relevant to examples that include KV caching. FIG. 5 is relevant to KV caching examples that include a single card or chip which performs both self-attention and feed-forwarding within a given transformer layer while. FIG. 7, like FIG. 5, illustrates how each partition of an LLM is partitioned into a smaller network such that all the trained weights contained in each of the smaller partitions are stored in the available on-chip memory, but in the case of FIG. 7, the system includes two chips, as opposed to one (FIG. 5).

FIG. 9 illustrates a transformer layer 315a where the transformer block is stored on one inference chip or inference accelerator and where the program code utilizes KV caching. Thus, FIG. 3 and FIG. 5 are relevant to this example. FIG. 9 is similar to FIG. 4 save for the inclusion of a KV cache 951, which is stored in on-chip activation memory 953. Like FIG. 4, FIG. 9 illustrates a transformer layer 315a where the transformer block is stored on one inference chip or inference accelerator. As aforementioned, in FIG. 9 each transformer layer is one card. In this example, a batch 322 of a given batch size includes hidden dimensions 324 (e.g., representations of data within the hidden layers, which are the intermediary layers between the input and output layers). The transformer layer 315a of the LLM includes an inference accelerator 326a. The weights of the transformer layer 315a are stored by the program code in on-chip memory 328 and the KV cache 951 is stored in on-chip activation memory 953. As in FIG. 4, the transformer layer 315a includes a self-attention stage 332a, which feeds a feed-forward stage 334a. The overviews provided in FIGS. 3 and 5 are relevant to FIG. 9. Thus, even when utilizing KV caching, output tensors from one stage are forwarded to another chip in a subsequent stage, the calculations accomplished by the LLM are separated into a number of batches, and each batch is processed on a chip that includes an inference accelerator. In this example, on-chip memory is shared between model weights and activation.

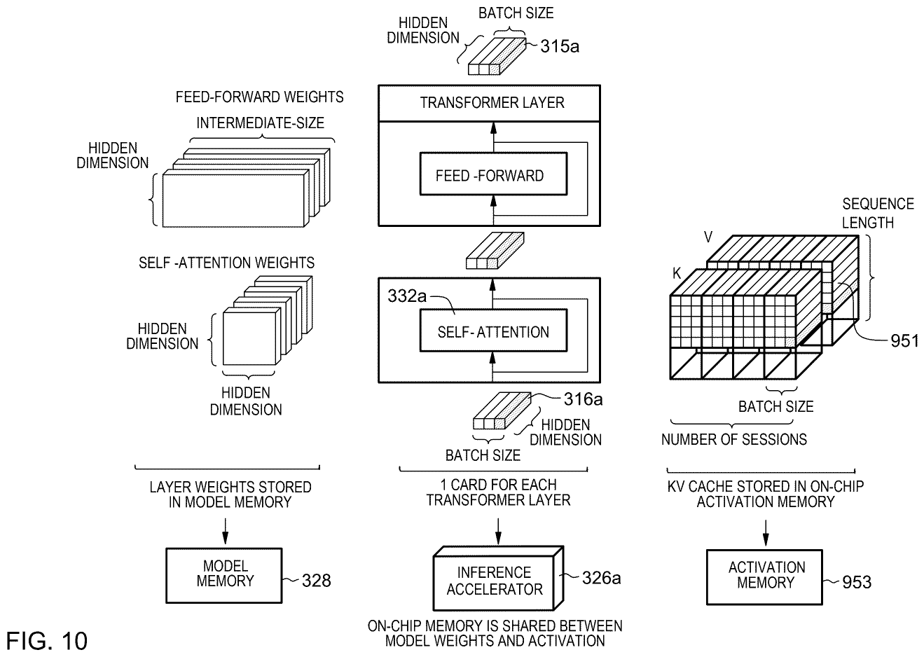

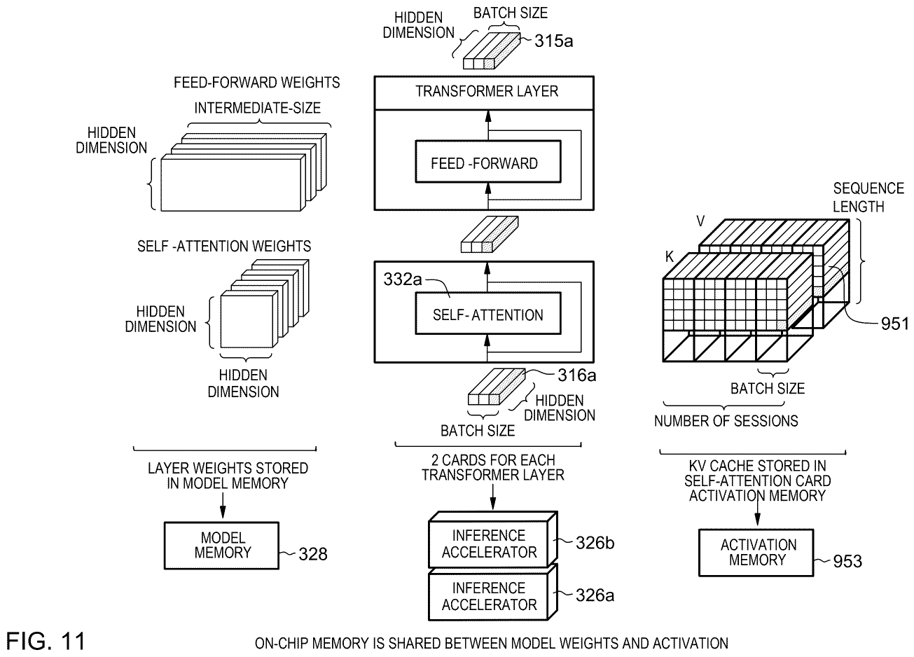

Examples herein that integrate KV caching in addition to utilizing the feed forward model described herein can support multiple user sessions and FIGS. 10-11 provide examples. However, while FIG. 10 illustrates an example that utilizes one chip or card per transformer layer, FIG. 11 illustrates an example that utilizes two chips per transformer layer. Specifically, the examples herein can sustain multiple user-sessions on a sequence of chips with on-chip memory and perform inference with activation-forwarding. To support the multiple user sessions, program code in certain of the examples herein stores the KV cache corresponding to each of the sessions in a separate memory location in the corresponding chip's on-chip memory. In some examples, when the program code generates a token for a user in a session, the KV cache for the corresponding user session is updated by the program code. FIG. 10 illustrates a transformer layer in examples where a KV cache 951 is stored in on-chip activation memory 953, as in FIG. 9, but there are a number of sessions 1071a-1071d, and various batches (the size of one batch 316 is indicated). FIGS. 3 and 5 are both relevant to examples that include multiple session KV caching but FIG. 10 is provided to illustrates the changes in the KV caching, which is a contrast between this example and others.

FIG. 10 is a single card model (like FIGS. 3-5) of some of the examples herein, but as illustrated in FIG. 6, two cards (or more than two cards) can be implemented. FIG. 11 is an overview of a transformer layer 315a in certain of the examples herein which include KV caching in addition to two inference two inference accelerators 326a-326b. The weights of the transformer layer 315a are stored by the program code in on-chip memory 328. The transformer layer 315a includes a self-attention stage 332a, which feeds a feed-forward stage 334a. The self-attention stage 332a and the feed-forward stage 334a are each on their own inference accelerators 326a-326b. Additionally, FIG. 11 illustrates aspects of an example herein where KV cache 951 for multiple user sessions are stored in inference chip's on-chip memory 953. In examples such as FIG. 11 that include KV caching as well as two chips, FIG. 7 illustrates how each partition of an LLM is partitioned into a smaller network such that all the trained weights contained in each of the smaller partitions are stored in the available on-chip memory of a two chips.

Certain examples herein provide the flexibility of storing different sets of instructions in on-chip memory. From a technical infrastructure standpoint, these examples utilize KV caching and two cards or chips for each transformer layer. FIGS. 12-13 provide illustrations of functionality related to the individual transformer layers but both FIGS. 3 and 7 provide overviews of these processes which are relevant. FIG. 12 illustrates functionalities within a transformer layer in the examples herein where the program code stores multiple sets of instructions in the sequence of chips with on-chip memory and chooses a different set during runtime based on (i) user session ID and/or (ii) KV cache initialization versus new token generation. Meanwhile, FIG. 13, which is also relevant to changing instructions, illustrates functionalities within a transformer layer where the program code modifies and uses the same set of instructions stored in the sequence of chips with on-chip memory for updating the KV cache and for generating several tokens based on the token ID.

Referring to FIG. 12, in this example processing performed by an inference chip or inference accelerator 326a-326b in the transformer layer 315a varies depending on whether the inference accelerator 326a-326b is just receiving one or more inputs that correspond to a prompt from a user that requires the inference accelerator 326a-326b to initialize the corresponding users KV cache 951, or whether the inference accelerator 326a-326b already contains a KV cache 951 corresponding to that user. In addition, since each user's KV cache 951 is maintained and updated separately in its on-chip memory, the sequence of instructions also differs based on user session ID. The size of the instructions utilized for each inference accelerator 326a-326b is much smaller than the size of weights and KV cache 951, maintaining and retrieving all the instructions in on-chip memory helps reduce the latency incurred during inference. The instructions are stored in model memory (e.g., on-chip memory 328). In this example, for self-attention (which is handled by one inference accelerator), the program code selects a specific set of self-attention instructions 1275a-1275d (from the available self-attention instructions 1274) at runtime based on session ID and whether the session is initializing KV cache 951 or updating it. The program code also selects a set of feed-forward instructions 1292a-1292d from the feed-forward instructions 1293 stored in model memory. The program code selects the feed-forward instructions at runtime based on whether the session is initiating KV cache or updating it. The difference between these two options is batch size as initializing could utilize a larger batch size. Other than the selection of instruction, this example operates much like the example illustrated in FIGS. 6-7.

FIG. 13 illustrates functionality performed at a transformer layer 315a when the program code in the examples herein modifies and use the same set of instructions stored in the sequence of chips with on-chip memory for updating the KV cache 951 and generating several tokens based on the token ID. In this example, when program code performing inferences with an LLM initializes its KV cache 951 with a user prompt, the program code generates a number of tokens for that user (subsequently) by using the token generated by the program code at each inference step as input to the system in the next inference step until the system generates a special token indicating that the model has reached a completion state. When the program code is generating the series of tokens in response to the user prompts, each token augments the KV cache 951 stored in on-chip memory by storing one or more of its generated outputs as part of the user's KV cache 951. In this example, the actual storage location can depend on an index of the series of generated tokens. Thus, the instructions utilized by the program code to perform inferences can differ slightly based on the index. For example, the program code can generate instructions with a placeholder for the KV cache update location, and the program code can fill this placeholder during runtime using the index of the token to be generated. The program code can also generate placeholders so that all user sessions may share a common set of instructions such that a user session's KV cache location is specified using a place-holder at compile time and updated during runtime when a specific user session ID is known. FIG. 13 illustrates this aspect because as indicated, the self-attention instructions 1275a-1275d are used to update the KV cache 951 and for each generated token the KV cache 951 is updated at a different location. The program code compiled the updated location with a place-holder and specified runtime (e.g., through an application packet).

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer-implemented method for performing inferences with activation forwarding, comprising:
obtaining, by one or more processors of a host, a large language model (LLM) for execution by the one or more processors;
partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and
performing, by the one or more processors, the inferences with activation-forwarding at each of the one or more transformer layers, the inferences with activation-forwarding comprising:
storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

2. The computer-implemented method of claim 1, wherein each transformer layer performs a self-attention action and a feed forward action.

3. The computer-implemented method of claim 1, wherein each transformer layer utilizes the on-chip memory of a single chip.

4. The computer-implemented method of claim 2, wherein each transformer layer utilizes the on-chip memory of a two chips, wherein a first chip of the two chips in utilized for the self-attention action and a second chip of the two chips is utilized for the feed forward action.

5. The computer-implemented method of claim 1, further comprising:
initializing, by the one or more processors, a key-value (KV) cache from user input;
storing, by the one or more processors, the KV cache on the sequence of chips utilizing the on-chip memory; and
utilizing, by the one or more processors, the activation-forwarding to generate user tokens and update the KV cache.

6. The computer-implemented method of claim 5, wherein the sequence of chips comprises directed-acyclic graph.

7. The computer-implemented method of claim 5, wherein storing the partitions comprises:
storing, by the one or more processors, for each transformer layer, multiple sets of instructions.

8. The computer-implemented method of claim 7, further comprising:
at runtime, at a given layer of the one or more transformer layers, selecting, by the one or more processors, for execution, a given set of instructions from the multiple sets of instructions; and
executing, by the one or more processors, the given set of instructions.

9. The computer-implemented method of claim 8, wherein selecting the given set of instructions comprises:
selecting, by the one or more processors, the given set of instructions based on a characteristic from the group consisting of: user session identifier, and type of instruction.

10. The computer-implemented method of claim 9, wherein the type of instruction is either a KV cache initialization instruction or a new token generation instruction.

11. The computer-implemented method of claim 5, wherein utilizing the activation-forwarding to generate user tokens comprises:
generating, by the one or more processors, a number of tokens for a user, the generating comprising:
at each inference step until a final inference step, generating a token and utilizing the token as input at a next inference step; and
at the final inference step, generating a special token indicating that the LLM has reached a completion state.

12. The computer-implemented method of claim 11, further comprising:
augmenting, by the one or more processors, the KV cache with each token of the number of tokens.

13. The computer-implemented method of claim 12, wherein the generating and the augmenting are contemporaneous.

14. The computer-implemented method of claim 1, wherein the LLM is transformer-based.

15. A computer system for performing inferences with activation forwarding, comprising:
a memory; and
one or more processors in communication with the memory, wherein the computer system is configured to perform a method, said method comprising:
obtaining, by the one or more processors of a host, a large language model (LLM) for execution by the one or more processors;
partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and
performing, by the one or more processors, the inferences with activation-forwarding at each of the one or more transformer layers, the inferences with activation-forwarding comprising:
storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

16. The computer system of claim 15, wherein each transformer layer performs a self-attention action and a feed forward action.

17. The computer system of claim 15, wherein each transformer layer utilizes the on-chip memory of a single chip.

18. The computer system of claim 16, wherein each transformer layer utilizes the on-chip memory of a two chips, wherein a first chip of the two chips in utilized for the self-attention action and a second chip of the two chips is utilized for the feed forward action.

19. A computer program product for performing inferences with activation forwarding, the computer program product comprising:
one or more computer readable storage media and program instructions collectively stored on the one or more computer readable storage media readable by at least one processing circuit to:
obtain a large language model (LLM) for execution by the one or more processors;
partition the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer; and
perform the inferences with activation-forwarding at each of the one or more transformer layers, the inferences with activation-forwarding comprising:
storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.

20. The computer program product of claim 19, wherein each transformer layer performs a self-attention action and a feed forward action.

21. The computer program product of claim 19, wherein each transformer layer utilizes the on-chip memory of a single chip.

22. The computer program product of claim 20, wherein each transformer layer utilizes the on-chip memory of a two chips, wherein a first chip of the two chips in utilized for the self-attention action and a second chip of the two chips is utilized for the feed forward action.

23. The computer program product of claim 19, the at least one processing circuit further to:
initial a key-value (KV) cache from user input;
store the KV cache on the sequence of chips utilizing the on-chip memory; and
utilize the activation-forwarding to generate user tokens and update the KV cache.

24. The computer program product of claim 23, wherein the sequence of chips comprises directed-acyclic graph.

25. A computer-implemented method for performing inferences with activation forwarding, comprising:
obtaining, by one or more processors of a host, a large language model (LLM) for execution by the one or more processors;
partitioning, by the one or more processors, the LLM, wherein each partition comprises a transformer layer of one or more transformer layers, and wherein the one or more transformer layers are situation between an embedding layer of the LLM and an output layer of the LLM, wherein layers of the LLM comprise the one or more transformer layers, the embedding layer, and the output layer, wherein each transformer layer performs a self-attention action and a feed forward action, and wherein each transformer layer utilizes the on-chip memory of a single chip; and
performing, by the one or more processors, the inferences with activation-forwarding at each of the one or more transformer layers, the inferences with activation-forwarding comprising:
storing, by the one or more processors, the partitions on a sequence of chips utilizing on-chip memory, wherein the storing comprises storing one or more trained weights comprising each transformer layer, wherein each transformer layer, upon obtaining input from a preceding layer of the layers, generates an output at each layer, and wherein the output at each layer of the layers excluding output generated at the output layer comprises the input to a succeeding layer, and wherein the output generated at the output layer comprises a result of the LLM.
